(19) United States
(12) Patent Application Publication
(10) Pub. No.: US 2015/0127431 A1
(43) Pub. Date: May 7, 2015

(54) Performance Evaluation System for Stores

(71) Applicant: Wal-Mart Stores, Inc., Bentonville, AR (US)

(72) Inventors: Steven Thomas, Bella Vista, AR (US); Richard Ulrich, Bentonville, AR (US); Willie Montgomery, III, Rogers, AR (US)

(73) Assignee: Wal-Mart Stores, Inc., Bentonville, AR (US)

(21) Appl. No.: 14/071,914

(22) Filed: Nov. 5, 2013

(51) Int. Cl. G06Q 10/06; G06F 17/30

(52) U.S. Cl. CPC G06Q 10/06393; G06F 17/30477
USPC 705/7.39

(57) ABSTRACT

Exemplary embodiments are generally directed to evaluating a performance of a store based on data representative of a transaction parameter for the store based on transactions at a point-of-sale terminal in the store. Exemplary embodiments can generate performance data for the store based on the transaction parameter. The performance data indicates performance of the store relative to a goal for a key performance indicator.

### TECHNICAL FIELD

The present disclosure relates to a performance evaluation system and, in particular, to a performance evaluation system for one or more stores, wherein the performance evaluation system determines a performance of the one or more stores based on information associated with an operation of point-of-sale terminals in the one or more stores.

### BACKGROUND

An entity operating stores may wish to determine how well the stores are performing relative to a specified goal and/or to each other. The task of evaluating the performance of one or more stores can become increasingly difficult as the number of stores increases and the location of the stores extends over many geographic regions. One reason it can become increasingly difficult to adequately evaluate performances of stores distributed over several geographic regions (e.g., states, countries, continents) is that stores located in the different geographic regions can implement different processes than each other. Conventional performance reporting tools often do not provide a requisite level of visibility into international markets to evaluate how well the current processes of the stores in these markets are working. The lack of visibility can make it difficult to determine whether processes implemented by the stores have been successful or whether adjustments should be made.

### SUMMARY

In accordance with embodiments of the present disclosure, a method of evaluating performance of a store is disclosed. The method includes collecting and storing in a database electronic data representative of a transaction parameter for the store based on transactions at a point-of-sale terminal in the store. The method includes receiving a performance evaluation request in a computer-readable format from a user via a graphical user interface. The performance evaluation request can specify a goal for a key performance indicator, e.g., a queue length compliancy, an ideal register utilization, an ideal register opening performance, an over ideal register opening performance, an under ideal register opening performance, a quantity of items scanned per hour, and the like. The method also includes executing code to query a database for electronic data representative of a transaction parameter for the store based on transactions at a point-of-sale terminal in the store in response to the performance evaluation request. The method further includes programmatically generating performance data for the store based on the transaction parameter. The performance data indicates performance of the store relative to the goal for the key performance indicator. The method includes executing code to output the performance data to the user.

In some embodiments, the methods include comparing the performance data for the store to performance data indicative of performance of at least one alternative store to determine performance of the store relative to the at least one alternative store. In some embodiments, the methods include comparing the performance data to the goal in response to at least one of generation of the performance data and an electronic request from a user. In some embodiments, the methods include determining an arrival rate of customers to the store for a specific time period and a service rate of the customers in the store for the specific time period. In some embodiments, the methods include executing code to determine an ideal register utilization defined by dividing the arrival rate by the service rate. In some embodiments, the methods include executing code to determine a total time spent waiting in line and being served defined by an inverse of a difference between the service rate and the arrival rate. In some embodiments, the methods include executing code to determine an average time waiting in line and being served defined by a difference between the total time spent waiting in line and being served and an inverse of the service rate. In some embodiments, the methods include executing code to determine an average number of customers in the store based on the arrival rate and the total time spent waiting in line and being served per customer. In some embodiments, the methods include executing code to determine an average number of customers in line based on the arrival rate and the average time waiting in line and being served. In some embodiments, the methods include executing code to determine a probability that the store is empty of customers based on the arrival rate, the service rate, and a number of point-of-sale terminals being operated. In some embodiments, the methods include executing code to determine an expected number of customers waiting in line based on the arrival rate, the service rate, the number of point-of-sale terminals being operated, and the probability that the store is empty. In some embodiments, the methods include executing code to determine a transaction time per customer based on a scan time, a tender time, a previous tender time and a miscellaneous time. In some embodiments, the methods include executing code to determine an item per hour based on a total number of items sold during the hour and the transaction time per hour. In some embodiments, at least one of the scan time, the tender time, the previous tender time and the miscellaneous time can be capped to reduce at least one of noise, abnormal values, and unrealistic values in the determination.

In accordance with embodiments of the present disclosure, exemplary non-transitory computer-readable medium storing computer-readable instructions are provided. Execution of the instructions by a processing device causes the processing device to implement a method of evaluating performance of a store that includes collecting and storing in a database electronic data representative of a transaction parameter for the store based on transactions at a point-of-sale terminal in the store. The method implemented upon execution of the instructions includes receiving a performance evaluation request in a computer-readable format from a user via a graphical user interface. The performance evaluation request can specify a goal for a key performance indicator, e.g., a queue length compliancy, an ideal register utilization, an ideal register opening performance, an over ideal register opening performance, an under ideal register opening performance, a quantity of items scanned per hour, and the like. The method implemented upon execution of the instructions also includes executing code to query a database for electronic data representative of a transaction parameter for the store based on transactions at a point-of-sale terminal in the store in response to the performance evaluation request. The method implemented upon execution of the instructions further includes programmatically generating performance data for the store based on the transaction parameter. The performance data indicates performance of the store relative to the goal for the key performance indicator. The method implemented upon execution of the instructions includes executing code to output the performance data to the user.

In some embodiments, execution of the instructions by the processing device can cause the processing device to compare the performance data to the goal in response to at least one of generation of the performance data and an electronic request from a user. In some embodiments, execution of the instructions by the processing device can cause the processing device to determine an arrival rate of customers to the store for a specific time period and a service rate of the customers in the store for the specified time period. In some embodiments, execution of the instructions by the processing device can cause the processing device to determine an ideal register utilization defined by dividing the arrival rate by the service rate. In some embodiments, execution of the instructions by the processing device can cause the processing device to determine a total time spent waiting in line and being served defined by an inverse of a difference between the service rate and the arrival rate. In some embodiments, execution of the instructions by the processing device can cause the processing device to determine an average time waiting in line and being served defined by a difference between the total time spent waiting in line and being served and an inverse of the service rate. In some embodiments, execution of the instructions by the processing device can cause the processing device to determine an average number of customers in the store based on the arrival rate and the total time spent waiting in line and being served per customer. In some embodiments, execution of the instructions by the processing device can cause the processing device to determine an average number of customers in line based on the arrival rate and the average time waiting in line and being served. In some embodiments, execution of the instructions by the processing device can cause the processing device to determine a probability that the store is empty based on the arrival rate, the service rate and a number of point-of-sale terminals being operated. In some embodiments, execution of the instructions by the processing device can cause the processing device to determine an expected number of customers waiting in line based on the arrival rate, the service rate, the number of point-of-sale terminals being operated and the probability that the store is empty. In some embodiments, execution of the instructions by the processing device can cause the processing device to determine a transaction time per customer based on a scan time, a tender time, a previous tender time and a miscellaneous time. In some embodiments, execution of the instructions by the processing device can cause the processing device to determine a scanned items per hour based on a total number of items sold during the hour and the transaction time per hour.

In accordance with embodiments of the present disclosure, exemplary retail performance evaluation systems for evaluating performance of a store are provided that generally include a computer storage device, a graphical user interface, and a processing device. The computer storage device stores electronic data representative of a transaction parameter for the store based on transactions at a point-of-sale terminal in the store. The processing device can be configured to receive a performance evaluation request in a computer-readable format from a user via the graphical user interface. The performance evaluation request can specify a goal for a key performance indicator. The processing device can be configured to execute code to query a database for electronic data representative of a transaction parameter for the store based on transactions at the point-of-sale terminal in the store in response to the performance evaluation request. The processing device can also be configured to programmatically generate performance data for the store based on the transaction parameter. The performance data indicates performance of the store relative to the goal for the key performance indicator. The processing device can be further configured to execute code to output the performance data to the user.

In some embodiments, the graphical user interface can be configured to receive an input of the goal for the key performance indicator. The processing device can be configured to compare the performance data to the goal in response to at least one of generation of the performance data and an electronic request from a user. In some embodiments, the processing device can be configured to execute code to determine an arrival rate of customers to the store for a specific time period and a service rate of the customers in the store for the specified time period. In some embodiments, the processing device can be configured to execute code to determine an ideal register utilization defined by dividing the arrival rate by the service rate. In some embodiments, the processing device can be configured to execute code to determine a total time spent waiting in line and being served defined by an inverse of a difference between the service rate and the arrival rate. In some embodiments, the processing device can be configured to execute code to determine an average time waiting in line and being served defined by a difference between the total time spent waiting in line and being served and an inverse of the service rate.

In some embodiments, the processing device can be configured to execute code to determine an average number of customers in the store based on the arrival rate and the total time spent waiting in line and being served per customer. In some embodiments, the processing device can be configured to execute code to determine an average number of customers in line based on the arrival rate and the average time waiting in line and being served. In some embodiments, the processing device can be configured to execute code to determine a probability that the store is empty of customers based on the arrival rate, the service rate and a number of point-of-sale terminals being operated. In some embodiments, the processing device can be configured to execute code to determine an expected number of customers waiting in line based on the arrival rate, the service rate, the number of point-of-sale terminals being operated and the probability that the store is empty. In some embodiments, the processing device can be configured to execute code to determine a transaction time per customer based on a scan time, a tender time, a previous tender time and a miscellaneous time. In some embodiments, the processing device can be configured to execute code to determine an items per hour based on a total number of items sold during the hour and the transaction time per hour.

Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed systems and associated methods, reference is made to the accompanying figures, wherein:

FIG. 1 is a block diagram of an exemplary performance evaluation system according to the present disclosure;

FIG. 2 is a block diagram of an exemplary line length calculation engine of a performance evaluation system according to the present disclosure;

FIG. 3 is a block diagram of an exemplary register calculation engine of a performance evaluation system according to the present disclosure;

FIG. 4 is a block diagram of an exemplary point-of-sale system according to the present disclosure;

FIG. 5 is a block diagram of an exemplary computing device configured to implement embodiments of an exemplary performance evaluation system according to the present disclosure;

FIG. 6 is a distributed client-server environment for implementing embodiments of an exemplary performance evaluation system according to the present disclosure;

FIG. 7 is an exemplary graphical user interface window of an exemplary performance evaluation system according to the present disclosure;

FIG. 8 is an exemplary graphical user interface window of an exemplary performance evaluation system according to the present disclosure;

FIG. 9 is an exemplary report generated by an exemplary performance evaluation system according to the present disclosure;

FIG. 10 is an exemplary report generated by an exemplary performance evaluation system according to the present disclosure;

FIG. 11 is an exemplary report generated by an exemplary performance evaluation system according to the present disclosure;

FIG. 12 is an exemplary report generated by an exemplary performance evaluation system according to the present disclosure;

FIG. 13 is an exemplary report generated by an exemplary performance evaluation system according to the present disclosure;

FIG. 14 is an exemplary report generated by an exemplary performance evaluation system according to the present disclosure;

FIG. 15 is an exemplary report generated by an exemplary performance evaluation system according to the present disclosure;

FIG. 16 is an exemplary report generated by an exemplary performance evaluation system according to the present disclosure; and

FIG. 17 is a flowchart illustrating implementation of an exemplary performance evaluation system according to the present disclosure.

### DETAILED DESCRIPTION

Exemplary embodiments of the present disclosure provide for a performance evaluation system that can be used to evaluate a performance of one or more stores across one or more geographic regions that may implement different processes. The evaluation of the performance of the stores can be utilized to determine how well the processes implemented by the stores are working based on POS terminal information collected from POS terminals in the stores. Exemplary embodiments of the performance evaluation system can advantageously provide a common global international reporting platform that can identify and/or calculate key performance indicator metrics for the stores that can be compared to specified goals for the stores and/or to key performance indicator metrics of other stores. As one example, exemplary embodiments of the present disclosure facilitate identifying and/or calculating key performance indicator metrics, such as estimated queue lengths or register utilization to evaluate how efficiently and effectively a store is in processing customer demand.

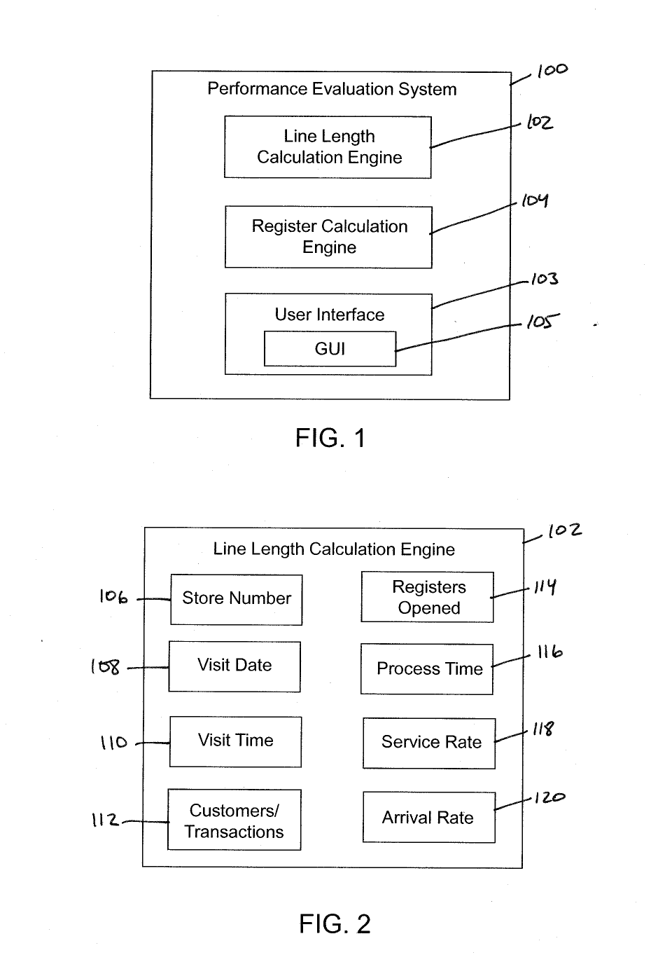

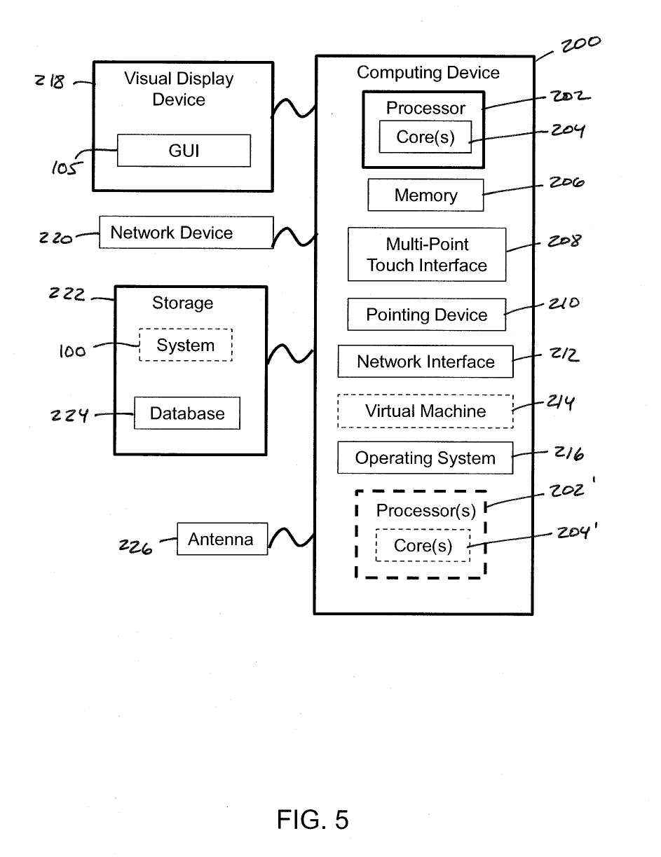

FIG. 1 is a block diagram of an exemplary performance evaluation system 100 (hereinafter “system 100”) that can be implemented using hardware, software, and/or a combination thereof. For example, in one exemplary embodiment, one or more computing devices can be programmed and/or configured to implement exemplary embodiments of the environment 100. An exemplary embodiment of a computing device configured to implement embodiments of the environment 100, or portions thereof, is depicted, for example, in FIG. 5. The system 100 can include a queue or line length calculation engine 102 (hereinafter “engine 102”) and a register calculation engine 104 (hereinafter “engine 104”).

In some embodiments, the system 100 can include a user interface 103. The user interface 103 can be programmed and/or can include executable code to provide at least one graphical user interface 105 (hereinafter “GUI 105”) through which a user can interact with the system 100. The GUI 105 displayed to users can include data entry areas to receive information from the user and/or can include data outputs to display information to the user. For example, one GUI 105 can allow a user to enter transaction parameters into the system 100, while another GUI 105 can display performance data to the user. Some examples of data entry fields include, but are not limited to, text boxes, check boxes, buttons, dropdown menus and/or any other suitable data entry fields.

In exemplary embodiments, the system 100 can be programmed and/or configured to determine and/or evaluate a performance of one or more stores, determine and/or evaluate an ideal utilization of point-of-sale (POS) terminals in the one or more stores, reduce queue wait times, and/or implement combinations thereof. The system 100 can be utilized by an entity to provide the entity with visibility into one or more stores, which can be distributed across several geographic regions (e.g. domestic and/or international stores) to evaluate how well processes implemented by the stores (e.g., current scheduling protocols) are working in relation to information associated with an operation of POS terminals in the stores (POS terminal information). This POS terminal information can correspond to point-of-sale data (e.g., raw data) collected from the POS terminals at each respective store and can include, for example, transaction times, number of registers opened, register utilization performance, estimated queue lengths, estimated queue wait times, basket sizes, and/or any other suitable information related to an operation of the POS terminals.

Using the collected POS terminal information, the system 100 can calculate a variety of key performance indicator metrics that can be used to evaluate the processes (e.g., scheduling protocols) implemented by the one or more stores. Some examples of key performance indicator metrics can include, for example, estimated queue lengths, average service rates, average arrival rates, register utilization, a number of queue exceptions, basket sizes, a number of transactions, and the like. Using the system 100, the one or more stores can be evaluated based on their individual performance and/or can be evaluated based on a collective performance with other stores (e.g., stores in a common geographic region can be evaluated collectively).

In some embodiments, the key performance indicator metrics can be calculated by the system 100 in specified time intervals (e.g., every fifteen minutes). The key performance indicator metrics calculated for consecutive time intervals (e.g., fifteen minute intervals) can be aggregated by the system to reflect performance of one or more stores over a selected time period (e.g., one hour). For example, the system 100 can provide key performance indicator metrics for an individual store every fifteen minutes and the system 100 can be programmed and/or configured to aggregate the key performance indicator metrics for four consecutive time intervals to generate a key performance indicator metric associated with one hour.

The system 100 can be used to evaluate performance of a store, a district, a region and/or a corporate view and/or can be used to measure the progress and efficiency of the stores and protocols implemented within the stores. In exemplary embodiments, the system 100 can evaluate a customer experience based on the key performance indicator metrics. The key performance indicator metrics can be used to determine how stores reacted to understaffed or overstaffed situations and how such reactions or protocols can be improved. The collected POS terminal information can therefore be turned into useful statistics regarding performance of one or more stores. In some embodiments, the system 100 can be used to evaluate an alternative system, such as a scheduling system for scheduling cashiers or staff. In some embodiments, the system 100 can be programmed and/or configured to determine the key performance indicator metrics and an alternative system, such as a scheduling system for scheduling cashiers or staff, can be use the key performance indicator metrics to correct the overstaffed or understaffed situations.

As depicted in FIG. 2, the engine 102 of the system 100 can receive as input transaction parameters included in the POS terminal information to determine line length for specified intervals. The transaction parameters utilized by the engine 102 can include, for example, a store number 106, a visit date 108, a visit time 110, a customers/transactions 112, a registers opened 114, a process time 116, and/or any other suitable transaction parameters. While the transaction parameters discussed herein are illustrative of exemplary transaction parameters, those skilled in the art will recognize that other and/or different transaction parameters can be specified.

The store number 106 can include one or more integer or alphanumeric indicators representative of a particular store in a specific location. The visit date 108 can include the date or day of the week of interest. The visit time 110 can include the time of day of interest. In some embodiments, the visit time 110 can include a visit time determined in fifteen minute intervals. The customers/transactions 112 can include a number of customers or transactions occurring. The registers opened 114 can include a number of registers which are opened in a particular store. The process time 116 can include a time for processing each customer or transaction at a POS terminal.

The transaction parameters can be utilized as input by engine 102 to calculate an average arrival rate λ (120) of customers to a store and an average service rate μ (118) of customers at the store. The average arrival rate λ can be in units of customers per minute per register and can be calculated based on Equation 1 below:

$$λ = \frac{( \frac{1}{15 min / customers} )}{Registers Open} \qquad ( 1 )$$

where Registers Open is a whole numerical value. The average service rate μ can be in units of customers per minute and can be calculated based on Equation 2 below:

$$μ = \frac{1}{[ \frac{( \frac{Process Time}{60 sec / min} )}{Customers} ]} \qquad ( 2 )$$

where Process Time is a whole numerical value in seconds and Customers is a whole numerical value.

Using the arrival rate λ and the service rate μ per a specified time interval, e.g., a fifteen minute interval, the utilization, time spent in line and average time waiting in line can be computationally determined and output by the engine 102. The utilization or proportion of time that an employee operating a POS terminal is busy can be calculated by the engine 102 based on Equation 3 below.

$$Utilization = \frac{λ}{μ} \qquad ( 3 )$$

In some embodiments, the ratio of Equation 4 for utilization can be upheld to ensure that the queue does not grow significantly large.

$$\frac{λ}{μ} < 1 \qquad ( 4 )$$

In an exemplary embodiment, the total time a customer waits in line and is served can be calculated by the engine 102 based on Equation 5 below:

$$W = \frac{1}{( μ - λ )} \qquad ( 5 )$$

where W represents the total wait time for a customer to stand in line and to be served. An average time waiting in queue or in line and being served (W_{q}) can be calculated by the engine 102 based on Equation 6 below.

$${W}_{q} = W - \frac{1}{μ} \qquad ( 6 )$$

Based on the total time spent waiting in line (W) and the average time waiting in line (W_{q}), the average number of customers in the system or in the store (L) and the average number of customers in the queue (L_{q}) can be calculated by the engine 102 with Equations 7 and 8 below:

L=λ×W (7)

L_{q}=λ×W_{q} (8)

Using Equations 7 and 8, the queue length and the queue time per register for a specified time interval, e.g., fifteen minute intervals, can be calculated by the engine 102. As discussed herein, in some embodiments, the calculations performed by the engine 102 and/or the results of the calculations can be provided to a user based on fifteen minute intervals. However, it should be understood that other timeframes can be utilized, e.g., thirty minutes, forty-five minutes, one hour, one day, one week, and the like. For example, in some embodiments, substantially similar calculations can be performed in fifteen minute intervals and the fifteen minute interval calculations can be grouped together to represent the desired timeframe, e.g., if a user wishes to view data representative of one hour, four fifteen minute intervals for the indicated timeframe can be grouped together and provided to the user.

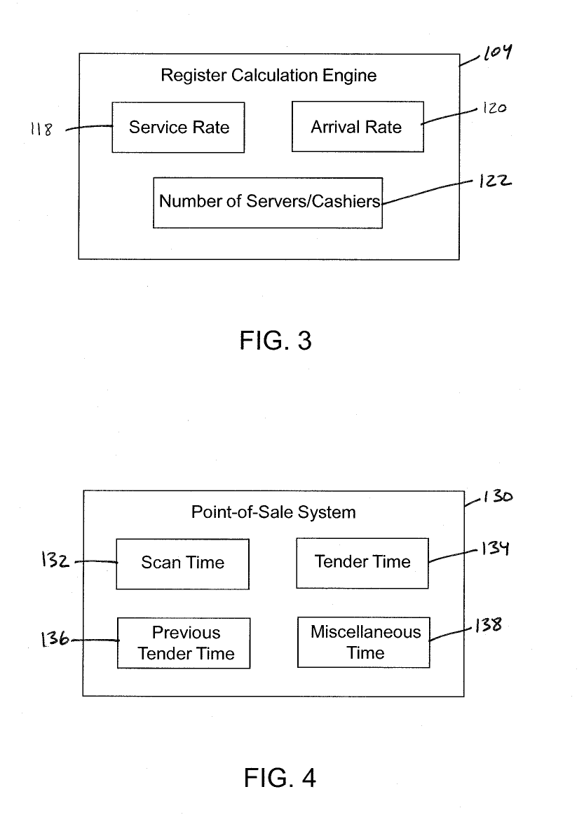

As depicted in FIG. 3, the engine 104 of the system 100 can use transaction parameters included in the POS terminal information to determine the number of POS terminals that should be open for servicing or accommodating customers in a timely manner. For example, the engine 104 can utilize the arrival rate λ (120) and the service rate μ (118), as derived herein, a number of servers/cashiers 122 scheduled or available, and/or any other suitable transaction parameters or values derived from the transaction parameters as input.

In some embodiments, a ratio defined by Equation 9 can be upheld to ensure that the queue does not grow significantly large.

$$\frac{λ}{s μ} < 1 \qquad ( 9 )$$

where s represents the number of POS terminals being operated by store employees.

A probability (P₀) that the system is empty (e.g., that there are no lines at the POS terminals) can be calculated by a Markovian process iteration of Equation 10 and an expected value (L_{q}) of the number of customers waiting in queue can be calculated with Equation 11.

$$\begin{matrix}{P}_{0} = {[ {\sum }_{n = 0}^{s - 1} \frac{{( \frac{λ}{μ} )}^{n}}{n !} + \frac{{( \frac{λ}{μ} )}^{s}}{s !} \times \frac{1}{( 1 - \frac{λ}{s μ} )} ]}^{- 1} & ( 10 ) \\ {L}_{q} = \frac{{( \frac{λ}{μ} )}^{s}}{s !} \times \frac{( \frac{λ}{s μ} )}{{[ 1 - ( \frac{λ}{s μ} ) ]}^{2}} \times {P}_{0} & ( 11 )\end{matrix}$$

Based on the probability (P₀) and the expected value (L_{q}) of the number of customers waiting in queue computed by the system 100, the engine 104 can be programmed and/or configured to determine whether to schedule more or less cashiers, e.g., whether to open or close POS terminals to accommodate the number of expected customers. Understaffed scenarios can thereby be reduced by opening a determined number of POS terminals in preparation for an increase in customers. Likewise, overstaffed scenarios can thereby be reduced by closing a determined number of POS terminal in preparation for a decrease in customers.

With reference to FIG. 4, an exemplary point-of-sale system 130 (hereinafter “POS system 130”) is provided. The POS system 130 can be implemented by one or more POS terminals in a store and/or can be in communication with the one or more POS terminals. The POS system 130 includes four distinct transaction/time categories into which transactions can be categorized. The POS system 130 can record time into the categories for each transaction event that occurs by capturing an amount of time that has elapsed since the last time the POS system 130 recorded time to a category. The four distinct transaction/time categories can include a scan time 132, a tender time 134, a previous tender time 136, and a miscellaneous time 138.

The scan time 132 can be the time from the first scanning and/or weighing of an item until a sub-total key on the POS system 130 is pressed to indicate an end of scanning. The tender time 134 can be the time from when the sub-total key is pressed until the tender key is pressed. The tender key can be for, e.g., cash, check, credit card, and the like. The previous tender time 136 can be the time from when a transaction is completed until the cash drawer of the POS system 100 is closed. The miscellaneous time 138 can be the time from when initial sign on occurs until a first scan occurs. The miscellaneous time 138 can also be the time from finalization of the last transaction until the first item of the next transaction is scanned. In exemplary embodiments, the system 130 (or the system 100) can be programmed and/or configured to calculate a transaction time per customer based on Equation 12 below:

Transaction Time=ST+TT+PTT+MT (12)

where ST represents the scan time 132, TT represents the tender time 134, PTT represents the previous tender time 136 and MT represents the miscellaneous time 138. The items per hour, i.e., the items scanned at a POS terminal by a cashier per hour, can be calculated by the system 130 (or system 100) based on Equation 13 below:

$$IPH = \frac{Items Sold}{Transaction Time} \qquad ( 13 )$$

where IPH represents the items per hour scanned at a POS terminal, Items Sold represents the total items sold per hour and the Transaction Time represents the total transaction time per hour. The transaction time and the items per hour values can be used by the system 130 (or system 100) to calculate the total process time of a cashier, e.g., a time a cashier took to serve each customer during a specific time interval (e.g., a fifteen minute interval).

In some embodiments, the times recorded to the transaction time categories, e.g., the scan time 132, the tender time 134, the previous tender time 136 and the miscellaneous time 138, can be capped to remove noise and/or abnormal/unrealistic values from the captured transaction times. In particular, the time can be capped for calculating the queue length and remain uncapped for calculating the items per hour. For example, if a price check is necessary during a transaction with a customer, a cashier may spend fifteen minutes determining the correct price, thereby skewing the process time. Such noise and/or abnormal/unrealistic values can be removed by capping each of the transaction times of the POS system 130. Tables 1 and 2, below, indicate the cap which can be placed on the transaction times for each type of calculation.

TABLE 1
Capped Time For Items Per Hour Calculation

| | | Previous | Miscellaneous |
|---|---|---|---|
| Scan Time | Tender Time | Tender Time | Time |
| Actual | Actual | Actual seconds | Capped to ≦15 |
| seconds per | seconds per | per transaction | seconds per |
| item scanned | transaction | | transaction |

TABLE 2
Capped Time For Queue Length Calculation

| | | Previous | Miscellaneous |
|---|---|---|---|
| Scan Time | Tender Time | Tender Time | Time |
| Capped to ≦60 | Capped to ≦90 | Capped to ≦90 | Capped to ≦90 |
| seconds per | seconds per | seconds per | seconds per |
| item scanned | transaction | transaction | transaction |

As depicted in Table 1, for the purpose of calculating the items per hour, the scan time 132 query can be represented by the actual seconds per item scanned. For the purpose of calculating a queue length, in some embodiments and as depicted in Table 2, the scan time 132 query can include a time constraint or cap of approximately 60 seconds per item scanned. If an item takes approximately 60 seconds or more to scan, the POS system 130 can recognize that this is an unrealistic scenario. Such scenarios can occur when a price check is necessary for an item being purchased. The approximately 60 second constraint can therefore ensure that more cashiers are not assigned because of situations such as price checks, customers requesting time to obtain additional merchandise, and the like.

As depicted in Table 1, for the purpose of calculating the items per hour, the tender time 134 query can be represented by the actual seconds per transaction. For the purpose of calculating a queue length, in some embodiments and as depicted in Table 2, the tender time 134 query can include a time constraint or cap of approximately 90 seconds per transaction. If the tender time for an item takes approximately 90 seconds or more, the cap of approximately 90 seconds can be placed on the tender time for the item. In particular, it is understood by those of ordinary skill in the art that the time from when a sub-total key is pressed on the POS terminal until a tender key, e.g., cash, check, credit card, and the like, is pressed generally does not require more than 90 seconds.

As depicted in Table 1, for the purpose of calculating the items per hour, the previous tender time 136 query can be represented by the actual seconds per transaction. For the purpose of calculating a queue length, in some embodiments and as depicted in Table 2, the previous tender time 136 query can include a time constraint or cap of approximately 90 seconds per transaction. In particular, if the time from when a transaction is completed until the cash register of a POS system is closed requires more than 90 seconds, the cap of approximately 90 seconds can be placed on the previous tender time 136 to prevent inaccurate calculations.

As depicted in Table 1, for the purpose of calculating the items per hour, in some embodiments, the miscellaneous time 138 query can include a time constraint or cap of approximately 15 seconds per transaction. For the purpose of calculating a queue length, in some embodiments and as depicted in Table 2, the miscellaneous time 138 query can include a time constraint or cap of approximately 90 seconds per transaction. For example, for the purpose of calculating the queue length or key performance indicator (KPI), if the time from when initial sign on until a first scan occurs or the time from finalization of the last transaction until the first item is scanned in the next transaction surpasses 90 seconds, the cap of approximately 90 seconds can be placed on the miscellaneous time 138 to prevent inaccurate results. For the purpose of calculating items per hour, if the time from when initial sign on until a first scan occurs or the time from finalization of the last transaction until the first item is scanned in the next transaction surpasses 15 seconds, the cap of approximately 15 seconds can be placed on the miscellaneous time 138 to prevent inaccurate results. In some embodiments, a hard sign-off and/or a soft sign-off can reset timers within the POS system 130 without saving the additional time spent during the hard sign-off and/or the soft sign-off and the subsequent transaction. Therefore, a hard sign-off and/or a soft sign-off can stop the miscellaneous time 138 bucket and place the POS terminal in a suspended mode until a subsequent transaction is initiated by signing on to the POS terminal.

For example, if a cashier signs on to the POS terminal, the miscellaneous time 138 counter can start. If a cashier does not want to affect his/her performance of items per hour (IPH), a soft sign-off at the POS terminal can be performed. As a further example, if the cashier wishes to take a bathroom break, a snack break, or to stand in front of the isle and wait for customers, a soft sign-off can be performed. The actual transaction times for each POS terminal or cashier can thereby be captured, while reducing noise and/or abnormal/unrealistic values.

Turning to FIG. 5, a block diagram of an exemplary computing device 200 configured to implement exemplary embodiments of the system 100 is provided. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the system 100. The computing device 200 also includes a configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (604 and 604′) processor.

Virtualization may be employed in the computing device 200 so that infrastructure and resourced in the computing device 200 may be shared dynamically. A virtual machine 214 may be provided to handle a process running on multiple processors 202 so that the process appears to be using only one computing resource rather than multiple computing resources. Multiple virtual machines may also be used with one processor 202.

Memory 206 may include a computer system memory or random access memory, such as DRAM, SRAM, EDO RAM, and the like. Memory 206 may include other types of memory as well, or combinations thereof.

A user may interact with the computing device 200 through a visual display device 218, such as a computer monitor, which may display one or more graphical user interfaces 105 that may be provided in accordance with exemplary embodiments. The computing device 200 may include other I/O devices for receiving input from a user, for example, a keyboard 208 or any suitable multi-point touch interface, a pointing device 210 (e.g., a mouse), and the like. The keyboard 208 and the pointing device 210 may be coupled to the visual display device 218. The computing device 200 may include other suitable conventional I/O peripherals.

The computing device 200 may also include one or more storage devices 222, such as a hard-drive, CD-ROM, or other computer-readable media, for storing data and computer-readable instructions and/or software that implement exemplary embodiments of the system 100 described herein. Exemplary storage device 222 may also store one or more databases 224 for storing any suitable information required to implement exemplary embodiments. For example, exemplary storage device 222 can store one or more databases 224 for storing information, such as store numbers, visit dates, visit times, customers/transactions, registers opened, process times, scan times, tender times, previous tender times, miscellaneous times, and the like, and values calculated from the transaction parameter values can include line lengths, a need for registers, service rates, arrival rates, number of servers/cashiers, and the like, to be used by embodiments of the system 100. The databases 224 may be updated manually or automatically at any suitable time to add, delete and/or update one or more items in the databases 224.

The computing device 200 can include a network interface 212 configured to interface via one or more network devices 220 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 200 can include one or more antennas 226 to facilitate wireless communication (e.g., via the network interface 212) between the computing device 200 and a network. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), point-of-sale terminal, internal corporate devices, or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 200 and performing the operations described herein. In exemplary embodiments, the operating system 216 may be run in native mode or emulated mode. In an exemplary embodiment, the operating system 216 may be run on one or more cloud machine instances.

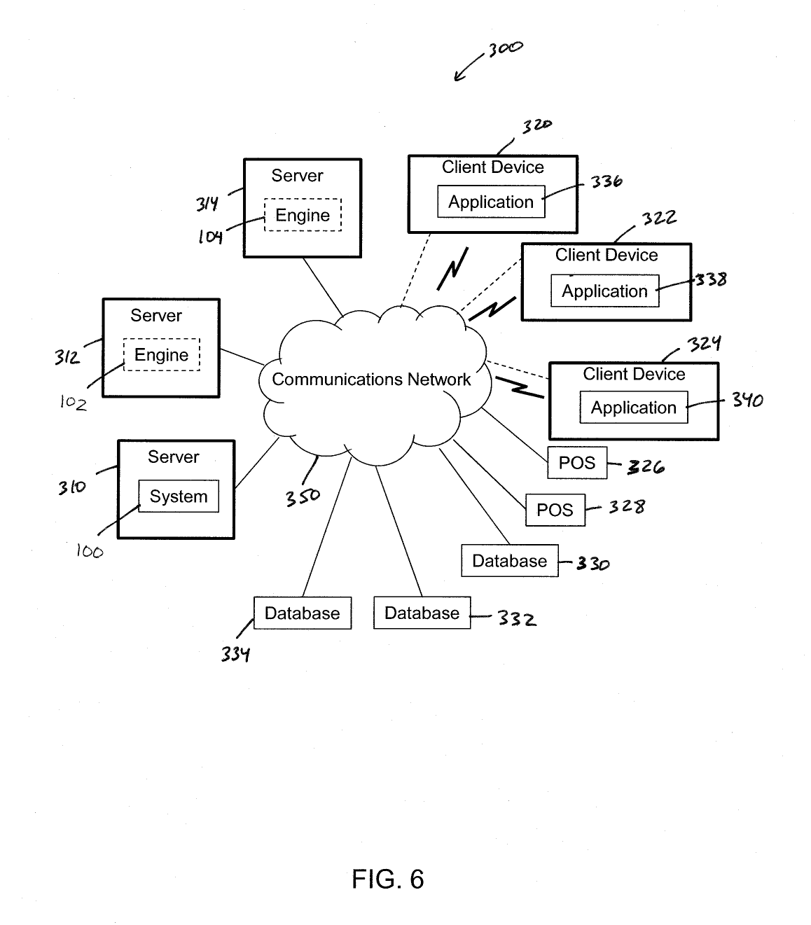

FIG. 6 is a block diagram of an exemplary client-server environment 300 configured to implement one or more embodiments of the system 100. The client-server environment 300 includes servers 310-314 operatively coupled to client devices 320-324 via a communications network 350, which can be any network over which information can be transmitted between devices communicatively coupled to the network. For example, the communications network 350 can be the Internet, an Intranet, a virtual private network (VPN), a wide area network (WAN), a local area network (LAN), and the like. The client-server environment 300 can include repositories or databases 330-334 which can be operatively coupled to the servers 310-314, as well as to client devices 320-324 via the communications network 350. The client-server environment 300 can include point-of-sale terminals 326-328 which can be operatively coupled to the servers 310-314, the client devices 320-324 and the databases 330-334 via the communications network 350. The servers 310-314, client devices 320-324, point-of-sale terminals 326-328, and databases 330-334 can be implemented as computing devices. Those skilled in the art will recognize that the database devices 330-334 can be incorporated into one or more of the servers 310-314 such that one or more of the servers 310-314 can include databases 330-334. In an exemplary embodiment, the system 100 can be implemented by the server 310. In some exemplary embodiments, the system 100 can be distributed over different servers 312-314. For example, the engine 102 can be implemented by the server 312 and the engine 104 can be implemented by the server 314.

The client devices 320-324 can include a client side application 336-340 programmed and/or configured to access and/or interface with the system 100. In the present embodiment, the client devices 320-324 can be computing devices including, for example, portable computing devices. In some embodiments, the client-side application 336 implemented by the client device 320 can be a web-browser capable of navigating one or more web pages hosting GUIs 105 of the system 100. In some embodiments, the client-side applications 336-340 implemented by one or more of the client devices 320-324 (e.g., portable computing devices) can be applications specific to the system 100 to permit access to the system 100 or the applications 336-340 can be the system 100. In some embodiments, the application specific to the system 100 can be a mobile application installed and executed by a portable computing device. In exemplary embodiments, the client devices 320-324 can be configured to communicate with the network 350 via wired and/or wireless communication.

The databases 330-334 can store information for use by the system 100. For example, the database 330 can store information related to the engine 102 transaction parameters, the database 332 can store information related to the engine 104 transaction parameters, and the database 334 can store information related to the system 130. In some exemplary embodiments, the databases 330-334 can store a combination of information related to the engine 102 transaction parameters, the engine 104 transaction parameters, and information related to the system 130.

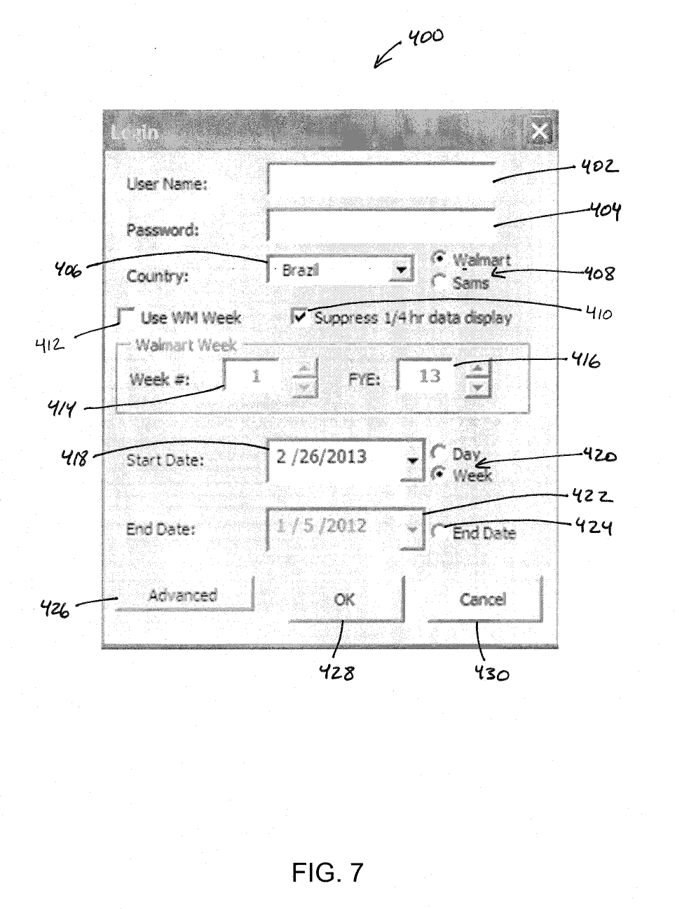

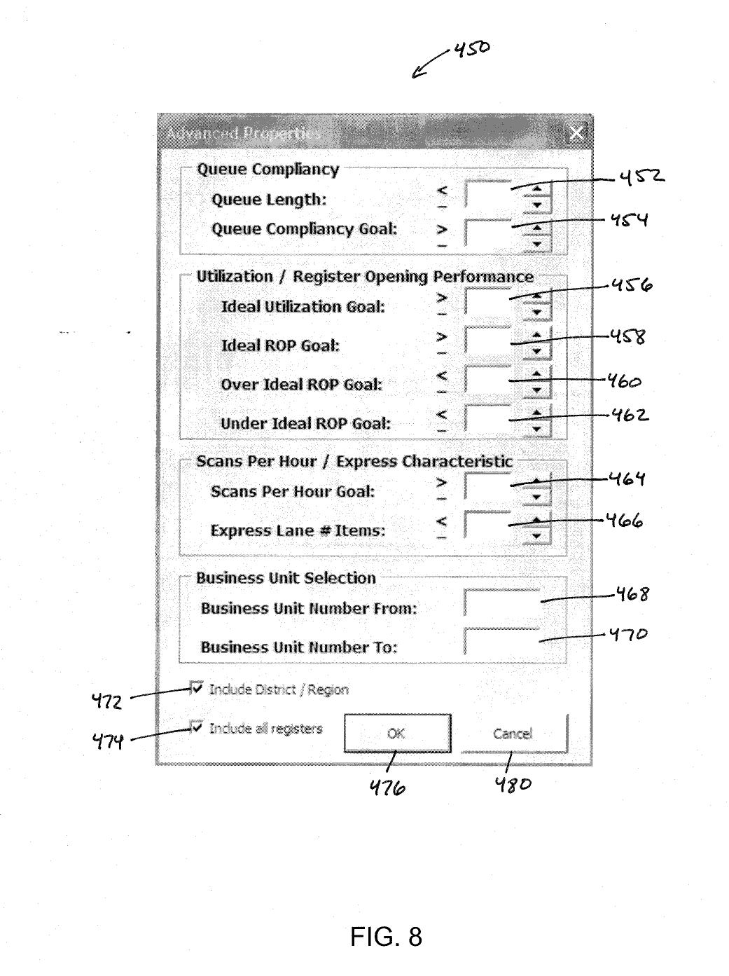

One or more graphical user interfaces can be included in some embodiments to facilitate user interaction with the performance evaluation system 100, the engine 102, the engine 104, the POS 130 and other features disclosed herein. With reference to FIG. 7, an exemplary graphical user interface window 400 (hereinafter “GUI window 400”) that can be rendered by the system 100 is provided which can provide key indicator metrics and/or POS terminal information to one or more users as reports (e.g., summaries, tables, spreadsheets, and/or any suitable data formats). It should be noted that the GUI window elements depicted and discussed herein are merely illustrative and other GUI window elements may be used in combination with or as a replacement of the GUI window elements discussed. The GUI window 400 provides a menu display which allows a user to input one or more parameters for generating a report with the system 100. For example, based on the parameters or limitations input by a user into the GUI window 400, the system 100 can be programmed and/or configured to output data based on the data collected at one or more POS terminals and by using Equations 1-16 discussed herein. In some embodiments, the GUI window 400 includes a user name 402 and a password 404 input field. The user name 402 and password 404 input can be implemented for security purposes and/or for storage of previously generated queries. The user name 402 and password 404 can further provide access permission to database tables which store the captured transaction parameter values discussed above. The country input 406 can include a dropdown menu for selection of a country of interest by the user. In some embodiments, if an entity owns two or more types of stores, the store of interest can be selected using store selection radio buttons 408. For example, as depicted in FIG. 7, the user can select between “Walmart” and “Sams”. In some embodiments, a dropdown menu can be provided for selection of the type of store.

A timeframe for generating or displaying data can be selected. For example, the system 100 can display data at a quarter hour level per store as a default setting. The user can suppress the quarter hour level data display by selecting the check box 410 to display data at a daily level. For a greater data display range, the check box 412 can be selected for a week selection. In particular, a week of interest can be input into the field 414 and a fiscal year end can be input into the field 416. In some embodiments, a start date can be selected in the field 418 and a selection of a data display for one day or for the entire week can be made by selecting the appropriate radio button 420. To select a greater data range, the start date can be selected or input into the field 418, the end date radio button 424 can be selected, and an end date can be selected or input into the field 422. An advanced settings or properties menu can be opened via a button 426. The query can be run by the system 100 for the selected fields by actuating the “OK” button 428 and the query can be canceled via the “Cancel” button 430.

FIG. 8 depicts an exemplary graphical user interface window 450 (hereinafter “GUI window 450”) for the advanced properties or settings menu of the system 100. As will be discussed in greater detail below, the GUI window 450 allows a user to manually input goals or targets for key performance indicators, e.g., queue length compliancy, utilization and/or register opening performance, scans per hour and express lane characteristics, business unit selections, and the like. It should be understood that the goal values and/or range of goal values provided herein are illustrative of exemplary embodiments and should not be considered limiting of the disclosure. For example, in some embodiments, the goal values can be in a greater or smaller range than the ranges provided herein. Based on the goals or targets input by a user into the GUI window 450, the system 100 can output data based on the data collected at one or more POS terminals and by using Equations 1-16 discussed herein to indicate performance of one or more stores relative to the input goals or targets.

The queue length compliance sub-window of the GUI window 450 allows the user to input a queue length and a queue compliancy goal into fields 452 and 454, respectively. For example, in some embodiments, the queue length field 452 can receive an input in the range of one to ten customers. As a further example, the desired queue length field 452 of FIG. 8 can be specified as less than or equal to two customers. In some embodiments, the queue compliancy goal field 454 can receive an input in the range of, for example, approximately 80 percent to approximately 100 percent. As a further example, the queue compliancy goal field 454 of FIG. 8 can be specified as greater than or equal to 98 percent. The system 100 can therefore flag data which shows that the desired queue length compliancy goal has not been met in a particular store.

The utilization/register opening performance sub-window of the GUI window 450 allows the user to input an ideal utilization goal, an ideal register opening performance (ROP) goal, an over ideal ROP goal and an under ideal ROP goal into fields 456, 458, 460 and 462, respectively. For example, in some embodiments, the ideal utilization goal field 456 can receive an input in the range of approximately 60 percent to approximately 90 percent. As a further example, the ideal utilization goal field 456 of FIG. 8 can be specified as greater than or equal to 75 percent. With respect to the ideal ROP goal, in some embodiments, the field 458 can receive an input in the range of approximately 75 percent to approximately 100 percent. As a further example, the ideal ROP goal field 458 of FIG. 8 can be specified as greater than or equal to 90 percent. With respect to the over ideal ROP goal, in some embodiments, the field 460 can receive an input in the range of approximately 5 percent to approximately 35 percent. As a further example, the over ideal ROP goal field 460 of FIG. 8 can be specified as less than or equal to 20 percent. With respect to the under ideal ROP goal, in some embodiments, the field 462 can receive an input in the range of approximately 0 percent to approximately 25 percent. As a further example, the under ideal ROP goal field 462 of FIG. 8 can be specified as less than or equal to 10 percent.

In some embodiments, an ideal utilization goal between approximately 75 percent and approximately 85 percent can represent a queue length of approximately three customers. In some embodiments, an ideal utilization goal of less than approximately 75 percent can represent a queue length range of approximately zero to two customers. In some embodiments, an ideal utilization goal greater than approximately 85 percent can represent a queue length of approximately five customers or more. The ideal ROP goal, the over ideal ROP goal and the under ideal ROP goal can be calculated based on the ideal utilization goal.

In some embodiments, the number of ideal registers opened as compared to the number of actual registers opened, e.g., the ROP, can be based on the processing time, e.g., the time spent servicing customers, divided by the time interval, e.g., 900 seconds for a fifteen minute interval, and multiplied by the ideal utilization goal value, e.g., 75 percent. The calculated value can further be rounded up to the nearest whole value. For example, if the calculated ROP value is 1.5, the ROP value can be rounded up to two since 1.5 registers cannot be opened. The ideal ROP value can represent the number of registers which should have been opened during a predetermined time interval with a specified ideal utilization goal value, e.g., 75 percent. The actual number of registers opened can then be compared to the number of registers which should have been opened to determine the over ideal ROP and under ideal ROP percentages which represent the over registered and under-registered percentages. The ideal number of registers opened can be calculated based on Equation 14 and the ROP value comparing the actual number of registers opened relative to the number of registers which should have been opened can be calculated based on Equation 15.

$$\begin{matrix}Ideal Number of Registers = \frac{Customer Process Time}{900 seconds} \times Ideal Utilization Goal & ( 14 ) \\ ROP = \frac{Actual Number of Registers Opened}{Ideal Number of Registers Opened} & ( 15 )\end{matrix}$$

It should be understood that the ideal number of registers calculated based on Equation 14 identifies the ideal number of registers for a fifteen minute time interval. In some embodiments, Equation 14 can be modified to include a customer process time for an alternative time interval and the 900 seconds can be modified to reflect the desired time interval, e.g., 1200 seconds for a twenty minute time interval.

The scans per hour/express characteristic sub-window of the GUI window 450 allows the user to input a scans per hour goal and an express lane number of items goal into fields 464 and 466, respectively. In particular, the scans per hour goal can represent the number of items scanned per hour at a regular checkout lane, while the express lane number of items goal can represent the number of items scanned per hour at an express checkout lane. For example, in some embodiments, the scans per hour goal field 464 can receive an input in the range of approximately 600 scans to approximately 1000 scans. As a further example, the scans per hour goal field 464 of FIG. 8 can be specified as greater than or equal to 800 scans. With respect to the express lane number of items goal, in some embodiments, the field 466 can receive an input in the range of approximately 5 items to approximately 35 items. As a further example, the express lane number of items goal field 466 of FIG. 8 can be specified as less than or equal to 20 items.

It should be understood that the scans per hour goal and the express lane number of items goal in fields 464 and 466 can be affected or selected by the type of front end process utilized by a specific store, a group of stores or a market. For example, a cashier working in the United States may scan and pack or bag the items sold. In contrast, a cashier working in Mexico may only scan the items sold, while a bagger or the customer packs or bags the items sold. The scans per hour goal set should therefore take into consideration the front end process being utilized at the store, the group of stores or the market. For example, in some embodiments, the scans per hour goal can be approximately 600 items per hour for the cashier in the United States who scans and packs the items sold, while the scans per hour goal can be approximately 900 items per hour for the cashier in Mexico who only scans the items sold. Similarly, the express lane number of items goal should be set while taking into consideration the way express lanes are defined in a store, a group of stores or a market. For example, in some embodiments, express lanes in the United States can be defined as lanes for customers with twenty items or less, while express lanes in Mexico can be defined as lanes for customers with thirteen items or less.

The business unit selection sub-window of the GUI window 450 allows the user to input a starting business unit number and an ending business unit number into fields 468 and 470, respectively, to indicate a range of business unit numbers which represent the stores of interest for which data will be displayed. It should be understood that the business unit selection sub-window can be used to select an individual store for viewing by inputting the same business unit number in the starting and ending business unit number fields 468 and 470. Similarly, the business unit selection sub-window can be used to select a group of stores for viewing by inputting a starting business unit number and an ending business unit number into fields 468 and 470. For example, in some embodiments, the starting business unit number field 468 and the ending business unit number field 470 can receive an input in the range of approximately zero to 9999. As a further example, the starting business unit number field 468 of FIG. 8 can be specified as zero and the ending business unit number field 470 of FIG. 8 can be specified as 9999 to represent the range of business unit numbers from zero to 9999.

Check box 472 can be selected to indicate whether the generated data should include information on stores in the district and/or region. Check box 474 can be selected to indicate that all POS terminals in the store(s) should be included in the generated data. In some embodiments, by default, the GUI window 450 can generate data on only front end POS terminals. In some embodiments, the GUI window 450 can be implemented to select the types of POS terminals for which the data should be generated, e.g., front end POS terminals, self-checkout lanes, electronics department POS terminals, pharmacy department POS terminals, photo department POS terminals, tire and lube department POS terminals, garden department POS terminals, and the like. The advanced properties input in the GUI window 450 can be saved by actuating the “OK” button 476 and the input properties or goals can be canceled by actuating the “Cancel” button 480.

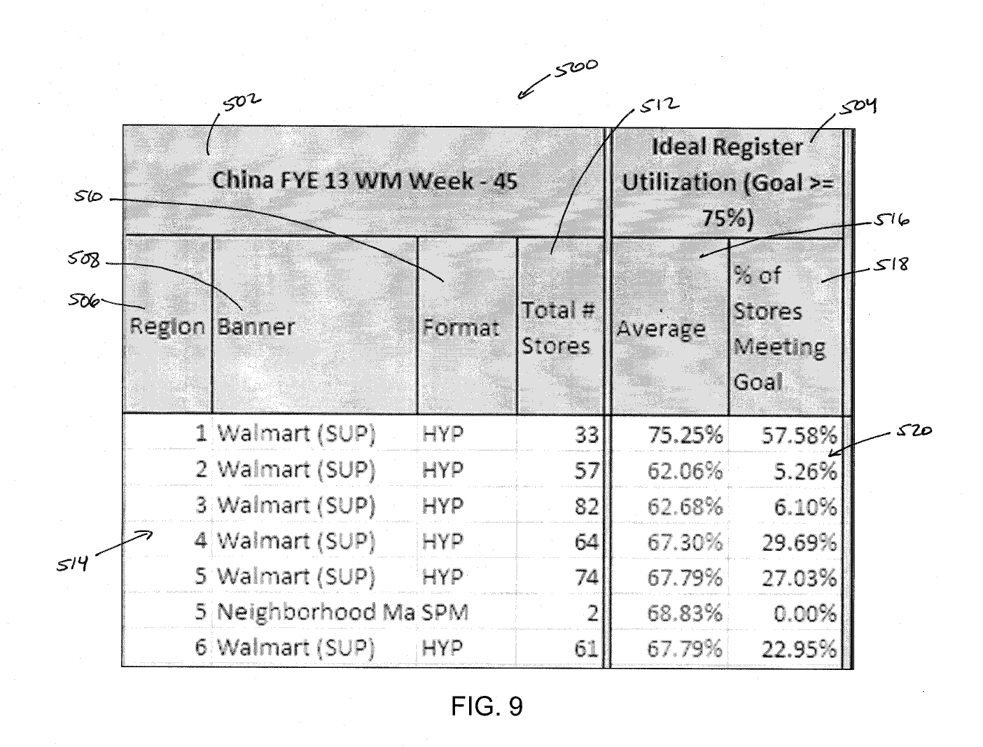

With reference to FIGS. 9-16, exemplary reports generated by the system 100 are provided. For example, based on input from a user into the GUI window 400 and GUI window 450, the system 100 can output useful statistics/metrics utilizing the data collected at one or more POS terminals as well as Equations 1-16 discussed herein to indicate performance of one or more stores relative to indicated goals or targets. With specific reference to FIG. 9, an exemplary ideal register utilization report 500 generated by the system 100 for the idea register utilization input in field 456 of the GUI window 450 is provided. In some embodiments, the ideal register utilization goal can be between approximately 60 percent and approximately 90 percent. As an example, the ideal register utilization goal implemented in FIG. 9 is greater or equal to 75 percent. As register utilization nears 100 percent, queue lines can grow because the average service rate is not keeping up with the average customer arrival rate.

FIG. 9 depicts the ideal register utilization report 500 which can include a first section 502 or header indicating the country, the fiscal year end, and the week for which the report 500 is generated. For example, FIG. 9 identifies the country as China, the fiscal year end as 2013 and the week as 45. The report 500 includes a second section 504 or header indicating the goal for which the report is generated. For example, FIG. 9 identifies the goal as the ideal register utilization and indicates that the goal is to have the ideal register utilization greater than or equal to 75 percent.

The report 500 can include one or more column sub-headings, e.g., a region 506, a banner 508, a format 510, a total number of stores 512, and the like. An array 514 of rows and columns can include the data generated for the respective column header for each listed store or region. It should be understood that the data depicted in the array 514 corresponds to data descriptive of the stores in the country of interest for the week of the fiscal year as indicated by the first section 502. The region 506 can indicate the region within the country for which data is being shown, e.g., region 1, region 2, region 3, and the like. The banner 508 can indicate the type of store for which data is being shown, e.g., a supermarket, a neighborhood market, and the like. The format 510 can indicate a format for a type of store, e.g., HYP for hypermarket, SPM for supermarket, SPC for supercenter, and the like. The total number of stores 512 can indicate the total number of applicable stores for the specific region, e.g., 33 stores for region 1, 57 stores for region 2, and the like.

Although depicted as a total number of stores for a specific region, it should be understood that the reports discussed herein can be generated for each individual store or for groups of two or more stores. In some embodiments, a user can select a row in the array 514 for a specific region by clicking on the respective row which can, in turn, expand a sub-array showing data representative of each individual store in the region. Thus, a user can determine which stores meet the indicated goal and which stores are below the indicated goal. Corrective action can further be taken to improve the performance of the stores which are below the indicated goal.

Similarly, the report 500 can include one or more column sub-headings, e.g., an average 516, a percent of stores meeting goal 518, and the like. An array 520 of rows and columns can include the data generated for the respective column header for each listed store or region. It should be understood that the data depicted in the array 520 corresponds to data relating to the ideal register utilization goal as indicated by the second section 504. The average 516 can indicate the average ideal register utilization for all stores in the respective region as a percentage, e.g., 75.25 percent for stores in region 1, 62.06 percent for stores in region 2, and the like. The percent of stores meeting goal 518 can indicate the percent of stores in the respective region which meet the goal indicated in ideal utilization goal field 456 of GUI window 450, e.g., 57.58 percent for stores in region 1, 5.26 percent for stores in region 2, and the like. Based on the generated data, more or less registers can be opened to raise the percent of stores meeting the goal. As discussed above, the generated data can be based on real data collected at POS terminals such that the system 100 can accurately indicate the number of ideal POS terminals to be opened for different parts of the day, e.g., more POS terminals can be opened during a rush hour portion of the day, less POS terminals can be opened late at night, and the like, due to the variation in the number of customers in the store during different parts of the day.

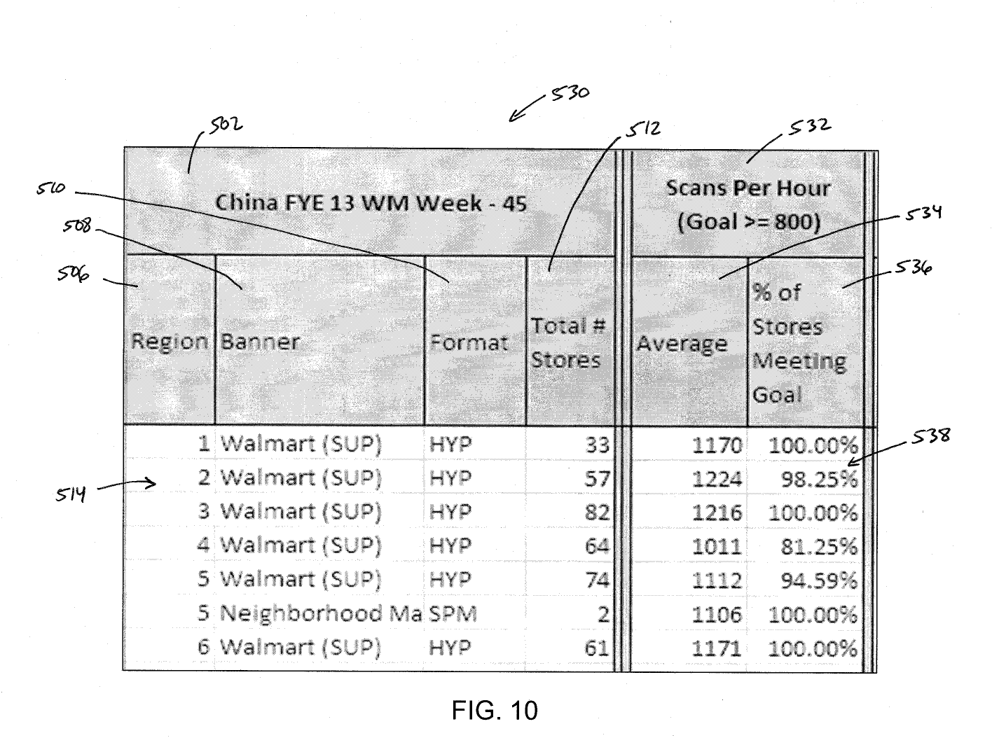

FIG. 10 depicts an exemplary scans per hour report 530 generated by the system 100 for the scans per hour goal input in field 464 of the GUI window 450. As discussed above, scans per hour represents the hourly rate of items being scanned at a POS terminal. It should be understood that each market may have different operational processes. For example, a cashier in the United States may scan and pack items, while a cashier in other markets may only scan the items while the customer or a bagger packs the items. Therefore, the scans per hour rate would be lower in the United States than the other markets. In some embodiments, the scans per hour goal can be in the range of approximately 600 scans and approximately 1000 scans. With respect to FIG. 10, as an example, the scans per hour goal is greater than or equal to 800. In some embodiments, the default value for the scans per hour goal can be set at 800.

The scans per hour report 530 can include a first section 502 substantially similar to the first section 502 of the ideal register utilization report 500, which indicates the country, the fiscal year end, and the week for which the report 530 is generated. The report 530 can include one or more column sub-headings, e.g., a region 506, a banner 508, a format 510, a total number of stores 512, and the like, substantially similar to the sub-headings of report 500. The report 530 further includes an array 514 of rows which include the data generated for the respective column header for each listed store or region. It should be understood that the data depicted in the array 514 corresponds to the data descriptive of the stores in the country of interest for the week of the fiscal year end as indicated by the first section 502.

The report 530 further includes a second section 532 or header indicating the goal for which the report 530 is generated. For example, FIG. 10 identifies the goal as the scans per hour and indicates that the goal is to have the scans per hour greater than or equal to 800. The second section 532 can include one or more column sub-headings, e.g., an average 534, a percent of stores meeting goal 536, and the like. An array 538 of rows and columns can include the data generated for the respective column header for each listed store or region. It should be understood that the data depicted in the array 538 corresponds to data relating to the scans per hour goal as indicated by the second section 532. The average 534 can indicate the average scans per hour for all stores in the respective region, e.g., 1170 scans per hour for stores in region 1, 1224 scans per hour for stores in region 2, and the like. The percent of stores meeting goal 536 can indicate the percent of stores in the respective region which meet the goal indicated in the scans per hour goal field 464 of GUI window 450, e.g., 100 percent for stores in region 1, 98.25 percent for stores in region 2, and the like.

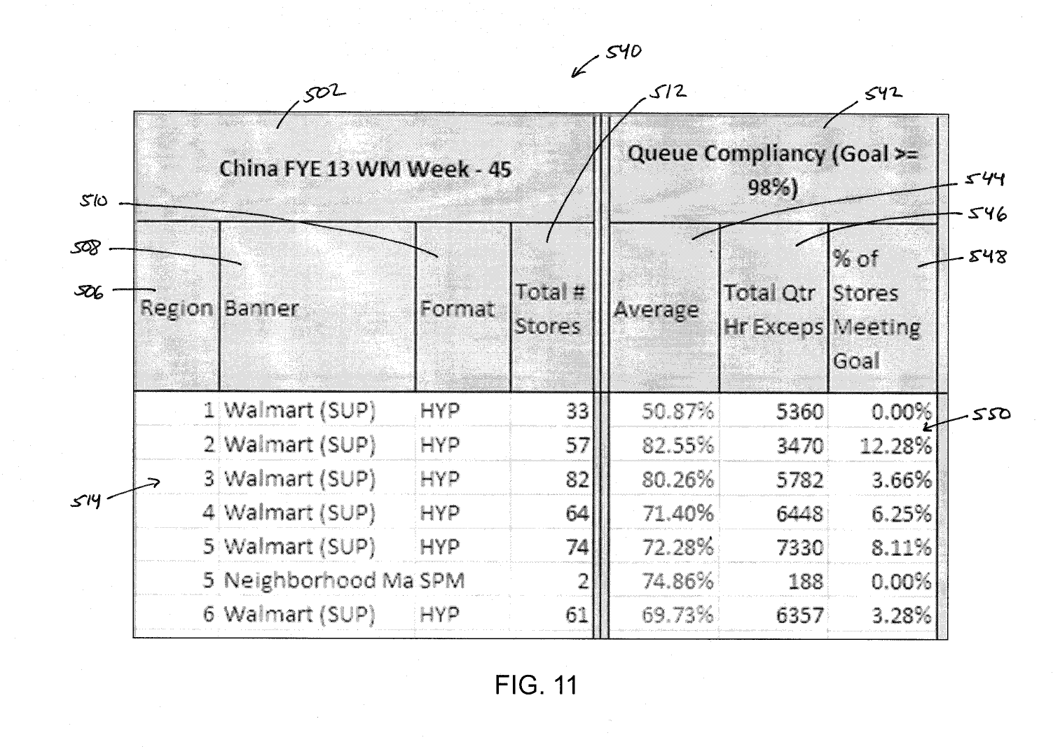

FIG. 11 depicts an exemplary queue compliancy report 540 generated by the system 100 for the queue compliancy goal input in field 454 of the GUI window 450. As discussed above, the queue length can be calculated for every fifteen minute bucket or transaction type, e.g., scan time 132, tender time 134, previous tender time 136, miscellaneous time 138, and the like, of each day in the report 540 date range. Queue compliancy can be determined by the number of times the queue length exceeds the defined queue threshold, i.e., the queue length input in the field 452, for a fifteen minute period divided by the total number of fifteen minute periods. In some embodiments, the queue compliancy goal can in the range of approximately 80 percent to approximately 100 percent. With respect to FIG. 11, as an example, the queue compliancy goal is greater than or equal to 98 percent.

The queue compliancy report 540 can include a first section 502 substantially similar to the first section 502 of the ideal register utilization report 500, which indicates the country, the fiscal year end, and the week for which the report 540 is generated. The report 540 can include one or more column sub-headings, e.g., a region 506, a banner 508, a format 520, a total number of stores 512, and the like, substantially similar to the sub-headings of report 500. The report 540 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 540 further includes a second section 542 or header indicating the goal for which the report 540 is generated. For example, FIG. 11 identifies the goal as the queue compliancy and indicates that the goal is to have the queue compliancy greater than or equal to 98 percent. The second section 542 can include one or more column sub-headings, e.g., an average 544, total quarter hour exceptions 546, a percent of stores meeting goal 548, and the like. An array 550 of rows and columns can include the data generated for the respective column header for each listed store or region. It should be understood that the data depicted in the array 550 corresponds to data relating to the queue compliancy as indicated by the second section 542. The average 544 can indicate the average queue compliancy relative to the desired queue length for all stores in the respective region, e.g., 50.87 percent for stores in region 1, 82.55 percent for stores in region 2, and the like. As discussed above, the calculations discussed herein can be performed for fifteen minute time intervals which can be aggregated up to, e.g., an hour, a day, a week, and the like, depending on the desired date range selected. The total quarter hour exceptions 546 can indicate a total or sum of the number of exceptions where a queue length was greater than the target value for each fifteen minute time interval. The total number of fifteen minute time intervals for the desired date range selected can then be utilized to determine the percentage of queue length compliancy. For example, the percentage of queue length compliancy can be determined based on Equation 16.

$$Queue Compliancy = \frac{( TQH - TQHE )}{TQH} \qquad ( 16 )$$

With respect to Equation 16, TQH can represent the total number of fifteen minute time intervals and TQHE can represent the total number of fifteen minute time intervals with a queue exception.

The percent of stores meeting goal 548 can indicate the percent of stores in the respective region which meet the goal indicated in the queue compliancy goal field 454 of GUI window 450, e.g., 0 percent for stores in region 1, 12.28 percent for stores in region 2, and the like. It should be noted that if a store and/or a region always meets or exceeds the queue compliancy goal, this may indicate that the particular store and/or region is overstaffed.

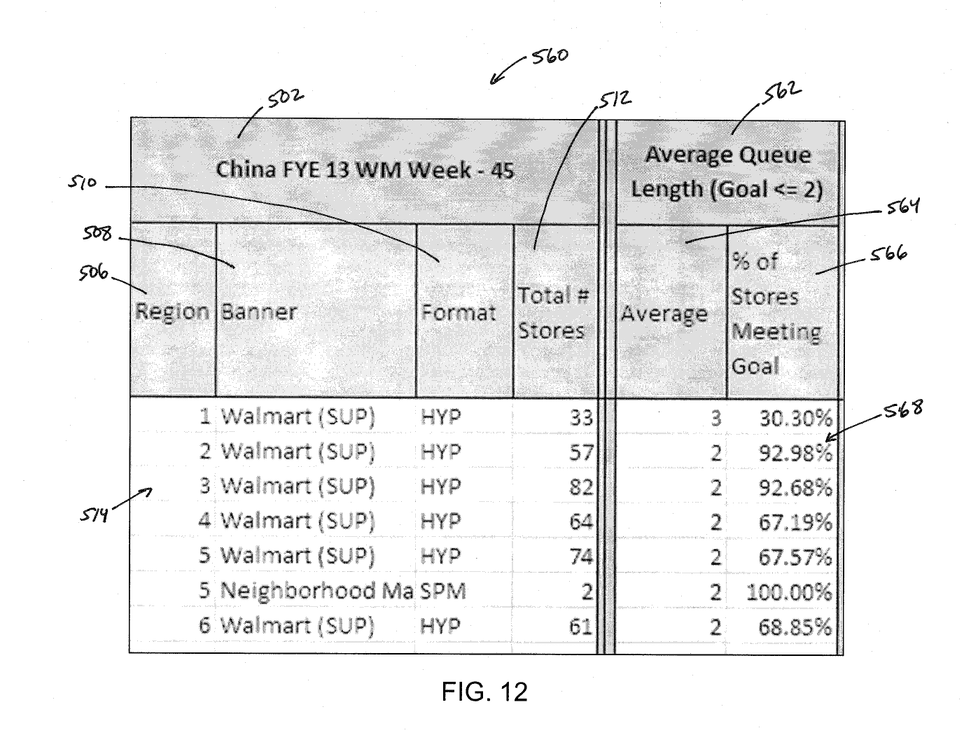

FIG. 12 depicts an exemplary average queue length report 560 generated by the system 100 for the queue length input in field 452 of the GUI window 450. As discussed above, average queue length represents the desired queue length of customers at POS terminals. The average queue length can be calculated based on the average service rate μ and the average arrival rate λ. The average queue length report 560 can include a first section 502 substantially similar to the first section 502 of the ideal register utilization report 500, which indicates the country, the fiscal year end, and the week for which the report 560 is generated. The report 560 can include one or more column sub-headings, e.g., a region 506, a banner 508, a format 510, a total number of stores 512, and the like, substantially similar to the sub-headings of report 500. The report 560 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 560 further includes a second section 562 or header indicating the goal for which the report 560 is generated. In some embodiments, the average queue length goal can be in the range of one to ten customers. For example, FIG. 12 identifies the goal as the average queue length and indicates that the goal is to have the average queue length less than or equal to two customers. The second section 562 can include one or more column sub-headings, e.g., an average 564, a percent of stores meeting goal 566, and the like. An array 568 of rows and columns can include the data generated for the respective column header for each listed store or region. It should be understood that the data depicted in the array 568 corresponds to data relating to the average queue length as indicated by the second section 562. The average 564 can indicate the average queue length for all stores in the respective region, e.g., 3 customers in the queue for stores in region 1, 2 customers in the queue for stores in region 2, and the like. The percent of stores meeting goal 566 can indicate the percent of stores in the respective region which meet the goal indicated in the queue length field 452 of GUI window 450, e.g., 30.30 percent for stores in region 1, 92.98 percent for stores in region 2, and the like.

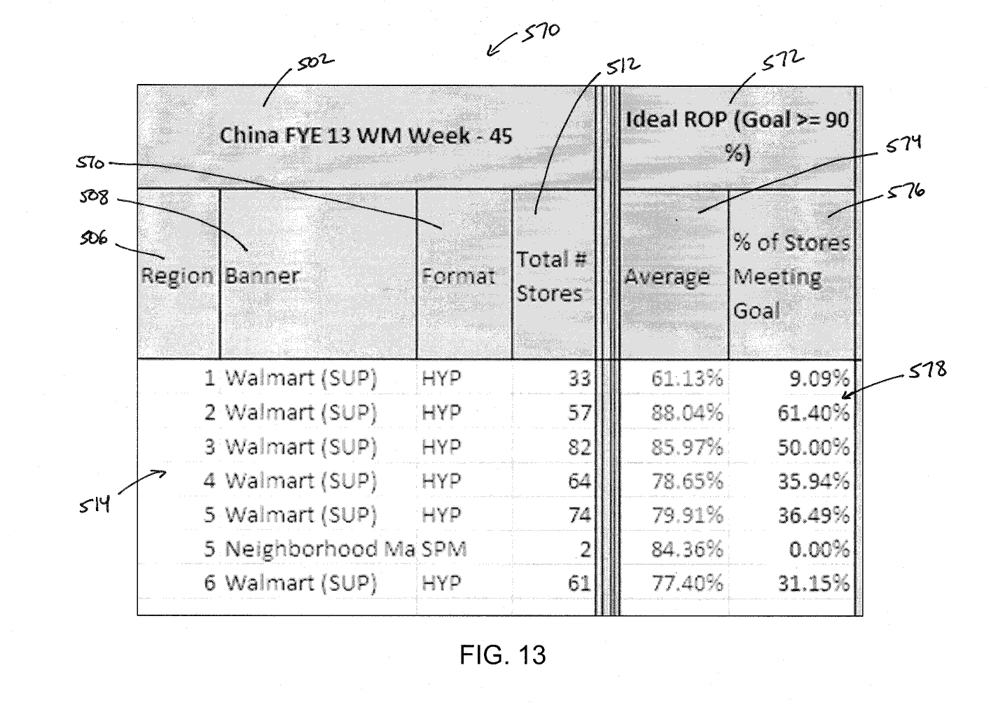

FIG. 13 depicts an exemplary ideal ROP report 570 generated by the system 100 for the ideal ROP goal input in field 458 of the GUI window 450. As discussed above, ideal ROP represents the ideal number of registers that should have been opened based upon actual POS terminal transaction data. The actual number of POS terminals opened can be compared by the system 100 against the ideal number of POS terminals to determine if, during each fifteen minute time period of the selected data range, the store had enough POS terminals opened to meet the actual demand.

The ideal ROP report 570 can include a first section 502 substantially similar to the first section 502 of the ideal register utilization report 500, which indicates the country, the fiscal year end, and the week for which the report 530 is generated. The report 570 can include one or more column sub-headings, e.g., a region 506, a banner 508, a format 510, a total number of stores 512, and the like, substantially similar to the sub-headings of report 500. The report 570 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 570 further includes a second section 572 or header indicating the goal for which the report 570 is generated. In some embodiments, the ideal ROP goal can be in the range of approximately 75 percent to approximately 100 percent. For example, FIG. 13 identifies the goal as the ideal ROP and indicates that the goal is to have the ROP greater than or equal to 90 percent. The second section 572 can include one or more column sub-headings, e.g., an average 574, a percent of stores meeting goal 576, and the like. An array 578 of rows and columns can include the data generated for the respective column header for each listed store or region. It should be understood that the data depicted in the array 578 corresponds to data relating to the ideal ROP goal as indicated by the second section 572. The average 574 can indicate the average ROP for all stores in the respective region, e.g., 61.13 percent for stores in region 1, 88.04 percent for stores in region 2, and the like. The percent of stores meeting goal 576 can indicate the percent of stores in the respective region which meet the goal indicated in the ideal ROP field 458 of GUI window 450, e.g., 9.09 percent for stores in region 1, 61.40 percent for stores in region 2, and the like.

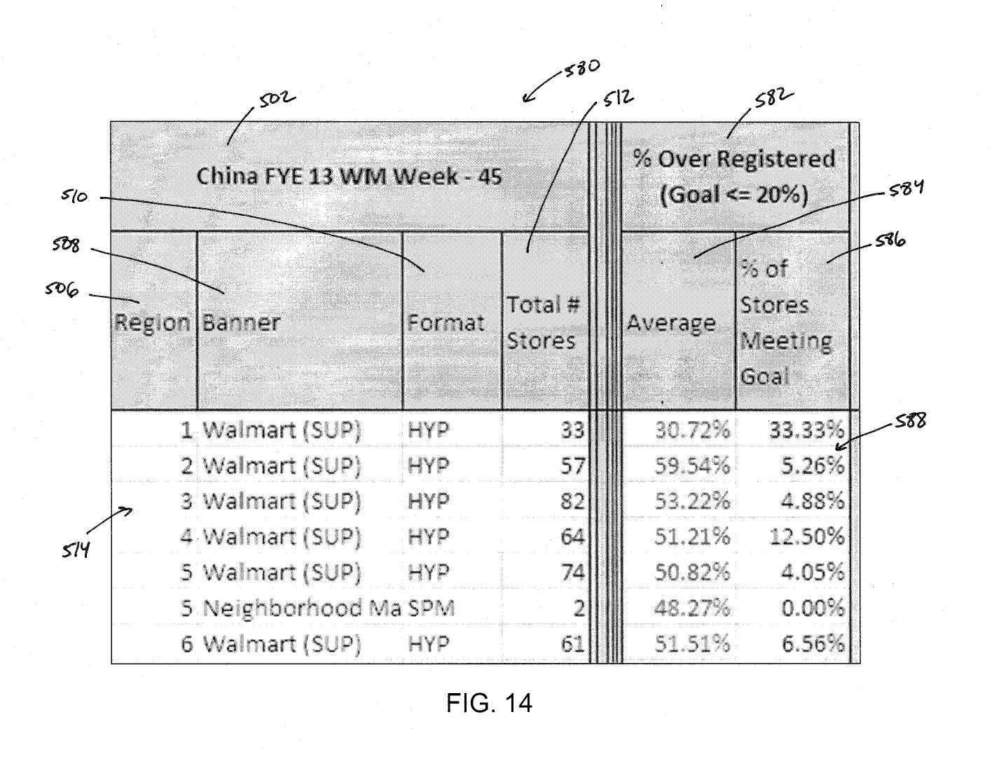

FIG. 14 depicts an exemplary percent over registered report 580 generated by the system 100 for the over ideal ROP goal input in field 460 of the GUI window 450. The percent over registered can be determined using the ideal register utilization value by calculating the ideal number of POS terminals that should have been opened based on actual POS terminal transaction data. The actual number of POS terminals opened can further be compared to the ideal number of POS terminals opened to determine if, during each fifteen minute time period of the selected data range, the store had more POS terminals opened than the ideal number of POS terminals.

The percent over registered report 580 can include a first section 502 substantially similar to the first section 502 of the ideal register utilization report 500, which indicates the country, the fiscal year end, and the week for which the report 580 is generated. The report 580 can include one or more column sub-headings, e.g., a region 506, a banner 508, a format 510, a total number of stores 512, and the like, substantially similar to the sub-headings of report 500. The report 580 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 580 further includes a second section 582 or header indicating the goal for which the report 580 is generated. In some embodiments, the percent over registered goal can be in the range of approximately 5 percent to approximately 35 percent. For example, FIG. 14 identifies the goal as the percent over registered and indicates that the goal is to have the percent over registered less than or equal to 20 percent. The second section 582 can include one or more column sub-headings, e.g., an average 584, a percent of stores meeting goal 586, and the like. An array 588 of rows and columns can include the data generated for the respective column header for each listed store or region. It should be understood that the data depicted in the array 588 corresponds to data relating to the percent over registered as indicated by the second section 582. The average 584 can indicate the average percent over registered for all stores in the respective region, e.g., 30.72 percent for stores in region 1, 59.54 percent for stores in region 2, and the like. The percent of stores meeting goal 586 can indicate the percent of stores in the respective region which meet the goal indicated in the over ideal ROP goal field 460 of GUI window 450, e.g., 33.33 percent for stores in region 1, 5.26 percent for stores in region 2, and the like.

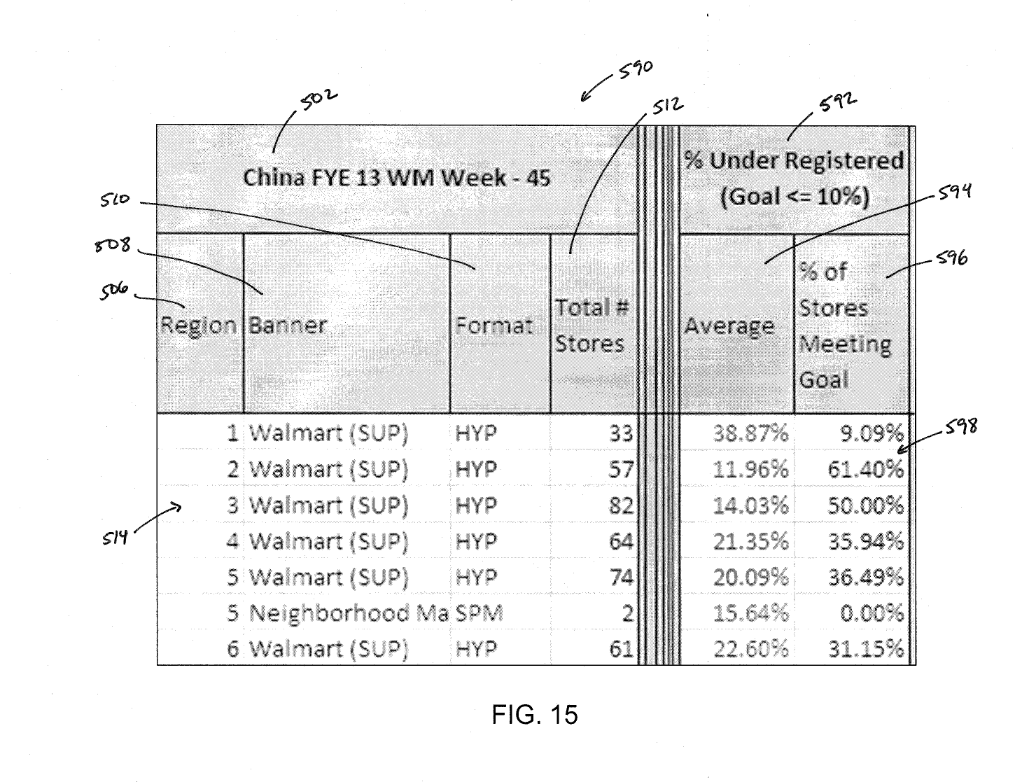

FIG. 15 depicts an exemplary percent under registered report 590 generated by the system 100 for the under ideal ROP goal input in field 462 of the GUI window 450. The percent under registered can be determined by using the ideal POS terminal utilization value and calculating the ideal number of POS terminals that should have been opened based on actual POS terminal transaction data. The actual number of POS terminals opened can further be compared to the ideal number of POS terminals opened to determine if, during each fifteen minute time period of the selected data range, the store has less POS terminals opened than the ideal number of POS terminals.

The percent under registered report 590 can include a first section 502 substantially similar to the first section 502 of the ideal register utilization report 500, which indicates the country, the fiscal year end, and the week for which the report 590 is generated. The report 590 can include one or more column sub-headings, e.g., a region 506, a banner 508, a format 510, a total number of stores 512, and the like, substantially similar to the sub-headings of report 500. The report 590 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 590 further includes a second section 592 or header indicating the goal for which the report 590 is generated. In some embodiments, the percent under registered goal can be in the range of approximately 0 percent to approximately 25 percent. For example, FIG. 15 identifies the goal as the percent under registered and indicates that the goal is to have the percent under registered less than or equal to 10 percent. The second section 592 can include one or more column sub-headings, e.g., an average 594, a percent of stores meeting goal 596, and the like. An array 598 of rows and columns can include the data generated for the respective column header for each listed store or region. It should be understood that the data depicted in the array 598 corresponds to data relating to the percent under ideal ROP goal as indicated by the second section 592. The average 594 can indicate the average percent under registered for all stores in the respective region, e.g., 38.87 percent for stores in region 1, 11.96 percent for stores in region 2, and the like. The percent of stores meeting goal 596 can indicate the percent of stores in the respective region which meet the goal indicated in the under ideal ROP goal field 462 of GUI window 450, e.g., 9.09 percent for stores in region 1, 61.40 percent for stores in region 2, and the like.

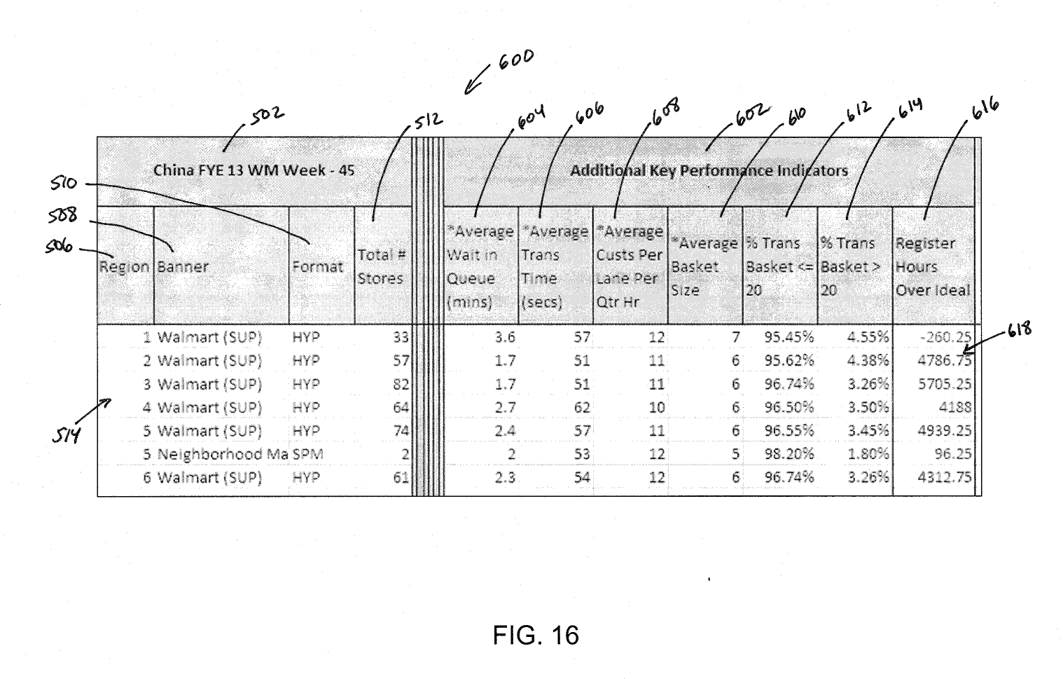

FIG. 16 depicts an exemplary additional key performance indicator report 600 generated by the system 100. The report 600 can include a first section 502 substantially similar to the first section 502 of the ideal register utilization report 500, which indicates the country, the fiscal year end, and the week for which the report 600 is generated. The report 600 can include one or more column sub-headings, e.g., a region 506, a banner 508, a format 510, a total number of stores 512, and the like, substantially similar to the sub-headings of report 500. The report 600 further includes an array 514 of rows and columns which include the data generated for the respective column header for each listed store or region. It should be understood that the data depicted in the array 514 corresponds to the data descriptive of the stores in the country of interest for the week of the fiscal year end as indicated by the first section 502.

The report 600 further includes a second section 602 or header indicating that the report 600 is generated for one or more additional key performance indicators. The second section 602 can include one or more column sub-headings for each of the one or more additional key performance indicators, e.g., an average wait in queue 604 measured in minutes, an average transaction time 606 measured in seconds, an average customers per lane per quarter hour 608, an average basket size 610 based on the number of items in a basket of a customer, a percent transactions 612, a percent transactions 614, a register hours over ideal 616, and the like. In some embodiments, the limit for the percent transactions 612 and/or 614 can be in the range of approximately 5 baskets to approximately 35 baskets. As an example, FIG. 16 indicates the limit for the percent transactions 612 and 614 as less than or equal to 20 baskets and greater than 20 baskets, respectively. An array 618 of rows and columns can include the data generated for the respective column header for each listed store or region. It should be understood that the data depicted in the array 618 corresponds to data relating to the additional key performance indicators as indicated by the column sub-headings of the second section 602.

The average wait in queue 604 can indicate the average wait time for customers in queue for all stores in the respective region, e.g., 3.6 minutes for stores in region 1, 1.7 minutes for stores in region 2, and the like. The average transaction time 606 can indicate the average time a transaction between a customer and a cashier for all stores in the respective region, e.g., 57 seconds per transaction for stores in region 1, 51 seconds per transaction for stores in region 2, and the like. The average customers per lane per quarter hour 608 indicates the average number of customers in each lane for each fifteen minute time interval for all stores in the respective region, e.g., 12 customers for stores in region 1, 11 customers for stores in region 2, and the like. The average basket size 610 indicates the number of items in a basket of a customer for all stores in the respective region, e.g., 7 items for stores in region 1, 6 items for stores in region 2, and the like. The percent transactions 612 can indicate the percent of transactions within a fifteen minute time interval of less than or equal to 20 baskets for all stores in the respective region, e.g., 95.45 percent for stores in region 1, 95.62 percent for stores in region 2, and the like. The percent transactions 614 can indicate the percent of transactions within a fifteen minute time interval of greater than 20 baskets for all stores in the respective region, e.g., 4.55 percent for stores in region 1, 4.38 percent for stores in region 2, and the like. The register hours over ideal 616 can be calculated daily by subtracting the actual number of POS terminals opened from the ideal number of POS terminals calculated to be opened for each fifteen minute time period of the day. The result can then be converted into daily hours over or under the ideal number of registers calculated to be opened time and the sum of all days in the selected date range for all stores for the respective region can be presented in the array 618, e.g., −260.25 hours under the ideal register opened hours for stores in region 1, 4786.75 hours over the ideal register opened hours for stores in region 2, and the like.

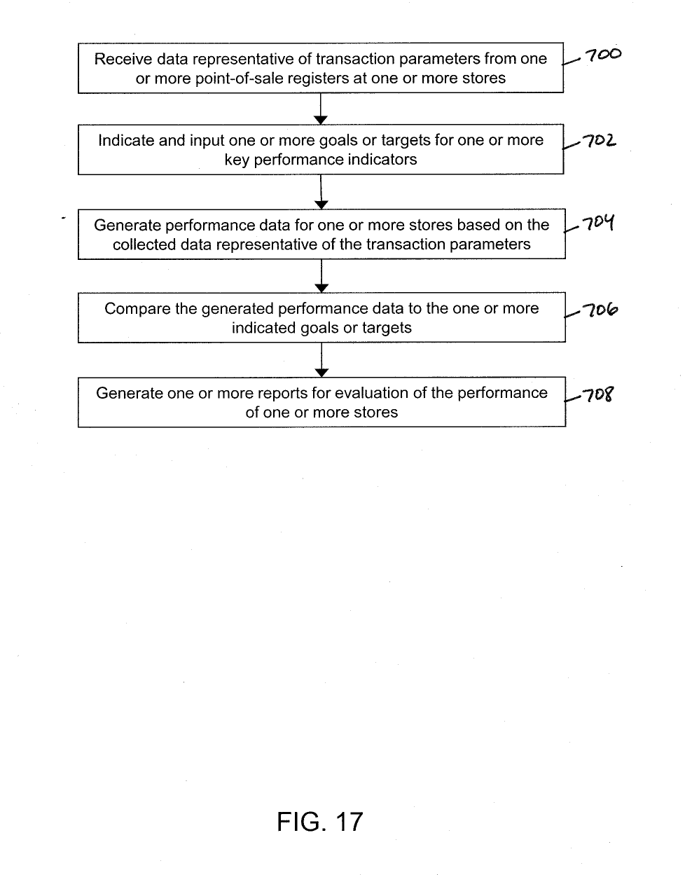

Turning to FIG. 17, a flowchart illustrating an exemplary method of a computer executable process carried out by the system 100 is provided. Data representative of transaction parameters, e.g., store numbers, visit dates, visit times, customers/transactions, registers opened, process times, and the like, from one or more POS terminals at one or more stores can initially be programmatically collected or received by embodiments of the system 100 (step 700). For example, the data representative of transaction parameters can be collected and stored in a database, and code can be programmatically executed to query the data representative of transaction parameters to the system 100. A user can specify and input one or more goals or targets, e.g., a queue compliancy goal, an ideal utilization goal, an ideal ROP goal, a scans per hour goal, and the like, for one or more key performance indicators via the GUI window 400 and/or the GUI window 450 (step 702). Performance data for one or more stores can be generated by the system 100 based on the collected data representative of the transaction parameters executing code of the system 100 to implement algorithms described herein (step 704). The generated performance data can be compared to the one or more indicated goals or targets to determine the performance and/or efficiency of the respective stores (step 706) and one or more reports can be generated by the system 100 to facilitate an evaluation of the performance of one or more stores (e.g., as described herein with respect to FIGS. 9-16) (step 708). In some embodiments, the performance data generated for a store can be compared to performance data indicative of performance of at least one alternative store. Performance of the store relative to one or more alternative stores can thereby be determined.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method of evaluating performance of a store, comprising:
receiving a performance evaluation request in a computer-readable format from a user via a graphical user interface, the performance evaluation request specifying a goal for a key performance indicator,
executing code to query a database for electronic data representative of a transaction parameter for the store based on transactions at a point-of-sale terminal in the store in response to the performance evaluation request,
programmatically generating performance data for the store based on the transaction parameter, wherein the performance data indicates performance of the store relative to the goal for the key performance indicator, and
executing code to output the performance data to the user.

2. The method according to claim 1, comprising comparing the performance data for the store to performance data indicative of performance of at least one alternative store to determine performance of the store relative to the at least one alternative store.

3. The method according to claim 1, comprising comparing the performance data to the goal in response to at least one of generation of the performance data and an electronic request from a user.

4. The method according to claim 1, wherein the key performance indicator comprises at least one of a queue length compliancy, an ideal register utilization, an ideal register opening performance, an over ideal register opening performance, an under ideal register opening performance, and a quantity of items scanned per hour.

5. The method according to claim 1, wherein programmatically generating performance data for the store based on the transaction parameter comprises:
determining an arrival rate of customers to the store for a specific time period and a service rate of the customers in the store for the specified time period, and
executing code to determine an ideal register utilization defined by dividing the arrival rate by the service rate.

6. The method according to claim 5, wherein programmatically generating performance data for the store based on the transaction parameter comprises:
executing code to determine a total time spent waiting in line and being served defined by an inverse of a difference between the service rate and the arrival rate, and
executing code to determine an average time waiting in line and being served defined by a difference between the total time spent waiting in line and being served and an inverse of the service rate.

7. The method according to claim 6, wherein programmatically generating performance data for the store based on the transaction parameter comprises:
executing code to determine an average number of customers in the store based on the arrival rate and the total time spent waiting in line and being served per customer, and
executing code to determine an average number of customers in line based on the arrival rate and the average time waiting in line and being served.

8. The method according to claim 5, wherein programmatically generating performance data for the store based on the transaction parameter comprises executing code to determine a probability that the store is empty based on the arrival rate, the service rate, and a number of point-of-sale terminals being operated.

9. The method according to claim 8, wherein programmatically generating performance data for the store based on the transaction parameter comprises executing code to determine an expected number of customers waiting in line based on the arrival rate, the service rate, the number of point-of-sale terminals being operated, and the probability that the store is empty.

10. The method according to claim 1, wherein programmatically generating performance data for the store based on the transaction parameter comprises:
executing code to determine a transaction time per customer based on a scan time, a tender time, a previous tender time, and a miscellaneous time, and
executing code to determine an items per hour defined by the following mathematical expression
$$IPH = \frac{Items Sold}{Transaction Time}$$
wherein Items Sold is a total number of items sold per hour and Transaction Time is the transaction time per hour.

11. The method according to claim 10, wherein at least one of the scan time, the tender time, the previous tender time, and the miscellaneous time is capped to reduce at least one of noise, abnormal values, and unrealistic values in the determination.

12. A non-transitory computer-readable medium storing instructions, wherein execution of the instructions by a processing device causes the processing device to implement a method of evaluating performance of a store, comprising:
receiving a performance evaluation request in a computer-readable format from a user via a graphical user interface, the performance evaluation request specifying a goal for a key performance indicator,
executing code to query a database for electronic data representative of a transaction parameter for the store based on transactions at a point-of-sale terminal in the store in response to the performance evaluation request,
programmatically generating performance data for the store based on the transaction parameter, wherein the performance data indicates performance of the store relative to the goal for the key performance indicator, and
executing code to output the performance data to the user.

13. The medium according to claim 12, comprising comparing the performance data to the goal in response to at least one of generation of the performance data and an electronic request from a user.

14. The medium according to claim 12, comprising executing code to determine at least one of an arrival rate, a service rate, an ideal register utilization, a total time spent waiting in line and being served, an average time waiting in line and being served, an average number of customers in the store, an average number of customers in line, a probability that the store is empty, an expected number of customers waiting in line, a transaction time, and an items per hour.

15. A retail performance evaluation system for evaluating performance of a store, comprising:
a computer storage device storing electronic data representative of a transaction parameter for the store based on transactions at a point-of-sale terminal in the store,
a graphical user interface, and
a processing device configured to (i) receive a performance evaluation request in a computer-readable format from a user via the graphical user interface, the performance evaluation request specifying a goal for a key performance indicator, (ii) executing code to query a database for electronic data representative of a transaction parameter for the store based on transactions at the point-of-sale terminal in the store in response to the performance evaluation request, (iii) programmatically generating performance data for the store based on the transaction parameter, wherein the performance data indicates performance of the store relative to the goal for the key performance indicator, and (iv) executing code to output the performance data to the user.

16. The system according to claim 15, wherein the processing device is configured to compare the performance data for the store to performance data indicative of performance of at least one alternative store to determine performance of the store relative to the at least one alternative store.

17. The system according to claim 15, wherein the graphical user interface is configured to receive an input of the goal for the key performance indicator, and wherein the processing device is configured to compare the performance data to the goal in response to at least one of generation of the performance data and an electronic request from a user.

18. The system according to claim 17, wherein the processing device is configured to execute code to determine at least one of an arrival rate, a service rate, an ideal register utilization, a total time spent waiting in line and being served, an average time waiting in line and being served, an average number of customers in the store, an average number of customers in line, a probability that the store is empty, an expected number of customers waiting in line, a transaction time, and an items per hour.

19. The system according to claim 18, wherein the processing device is configured to execute code to determine an ideal register utilization defined by dividing the arrival rate by the service rate.

20. The system according to claim 18, wherein the processing device is configured to execute code to determine:
an average number of customers in the store based on the arrival rate and the total time spent waiting in line and being served per customer, and
an average number of customers in line based on the arrival rate and the average time waiting in line and being served.
